(19) United States
(12) Patent Application Publication
(10) Pub. No.: US 2025/0017143 A1
(43) Pub. Date: Jan. 16, 2025

(54) PICK-UP ATTACHMENT FOR A HARVESTING MACHINE

(71) Applicant: Carl Geringhoff GmbH & Co. Kommanditgesellschaft, Ahlen (DE)

(72) Inventors: André HEMMESMANN, Sassenberg (DE); Andreas LEUDERALBERT-BOWE, Gronau (DE); Reimer Uwe TIESSEN, Oldenburg (DE); Holger STRUNK, Wadersloh (DE); Cristiano SCHWARTZ, Ahlen (DE)

(73) Assignee: Carl Geringhoff GmbH & Co. Kommanditgesellschaft, Ahlen (DE)

(21) Appl. No.: 18/710,769

(22) PCT Filed: Dec. 13, 2022
(86) PCT No.: PCT/DE2022/100948

§ 371 Date: May 16, 2024

(30) Foreign Application Priority Data
Dec. 22, 2021 (DE) 10 2021 134 284.8

(51) Int. Cl. A01D 43/06

(52) U.S. Cl. CPC A01D 43/06

(57) ABSTRACT

A pick-up attachment for a harvesting machine includes a pick-up rotor having pick-up tools for picking crop up from the ground. The pick-up rotor is connected to at least one guide element on the ground that guides the pick-up rotor to the ground. The pick-up rotor along with the at least one guide element is suspended on the machine frame of the pick-up attachment by control arms, so as to swing. Each control arm is connected to the pick-up rotor with one end, in an articulated manner, and to the machine frame with the other end, in an articulated manner, so that during push travel of the pick-up attachment, a push point forming the attack point of a thrust direction vector defined by the control arms is arranged below the contact point that forms between the ground and the guide element, when the pick-up rotor assumes a certain position.

The invention relates to a pick-up attachment for a harvesting machine, preferably for a field chopper, in particular for a self-propelled field chopper, comprising a pick-up rotor having pick-up tools for picking crop up from the ground, wherein the pick-up rotor is connected to at least one guide element that rests on the ground, which element takes on the guidance of the pick-up rotor and guides it to the ground.

Field choppers are harvesting machines that are used for harvesting and collecting crop, cutting crop to short parallel lengths, and conveying the chopped material into containers or separate vehicles. Typical crops are grasses, pulses, mixtures and/or crops grown in rows, such as maize or millet. The chopped material can either be stored by means of silage or drying, or can be fed to the livestock directly. The field chopper can harvest the crop directly, by means of cutting it off over its full width or from individual or multiple rows, or by picking it up from the swath. Field choppers can be attached to a tractor, pulled by a tractor, or self-propelled.

A harvesting attachment is a device, usually removable, for holding the crop in the field chopper. In the case of a pick-up attachment as a harvesting attachment, this is specifically a device for holding crop that has been cut previously. In this regard, the crop can be laid down in rows or swaths.

Self-propelled field choppers have achieved a motor power of over 1000 hp in the meantime. Parallel to the motor power, the through-put power of the field choppers has also increased. Aside from the high motor and through-put power that is necessary for corn silage, the harvesting capacity in grass silage is also an important factor for high fodder quality. After mowing, the meadows and fields must be cleared within a short period of time, so as to be able to silage the green fodder with an optimal dry substance content, for example.

In order to make use of the high throughput capacity of the harvesting machines, in particular of the field choppers, it is necessary, among other things, to clearly increase the forward travel speed of the harvesting machine.

An increase in the working speed or the forward travel speed of the harvesting machine, in particular of the field chopper, as a quasi investment-neutral increase in the harvesting capacity, is accompanied by negative side effects, which are described in greater detail below.

The drivers of field choppers and transfer vehicles require a clearly greater degree of concentration at higher forward travel speeds, so that the exhaustion limit is reached much earlier. As a result, changes in the contour of the ground, brought about by field ditches, for example, in other words by narrow ditches between individual fields, which serve for water drainage, by wet spots, or by other hindrances, are only detected at a late point in time, and therefore timely manual adaptation of the forward travel speed and of the height of the pick-up attachment is made more difficult.

Known pick-up attachments comprise a rigid, roller-like pick-up rotor having pick-up tools, for example a rigid zinc drum for picking crop up from the ground. In this regard the pick-up rotor is firmly connected, in other words also quasi rigidly connected or attached to the machine frame of the pick-up attachment. Such pick-up rotors cannot adapt to the contour of the ground separately, in other words separately from the machine frame of the pick-up attachment. Furthermore, pick-up attachments are known, which as such are rigidly connected or attached to the machine frame of the harvesting machine, in particular of the field chopper. Pick-up attachments rigidly connected to the harvesting machine or pick-up attachments having a rigidly connected pick-up rotor usually demonstrate poor ground tracking in undulating areas.

It is known that harvesting machines, for example field choppers, usually have a contact pressure control device as well as a pendulum plate for height guidance or ground adaptation of the pick-up attachment. The pendulum plate is usually a frame-shaped element that is articulated, with one side, onto the harvesting machine, for example onto the front end of the field chopper, so as to pivot about a pendulum axis, and is attached to the pick-up attachment with the other side, or is supported on the machine frame of the pick-up attachment. The pendulum plate thereby allows a pivoting movement of the pick-up attachment relative to the harvesting machine, in particular of the field chopper, about a horizontal pendulum axis. The pivoting of the pick-up attachment and of the pendulum plate about the pendulum axis can take place as the result of gravity, or actuators activated by outside forces are provided, which vary or control the pivot angle about the pendulum axis automatically, based on signals from sensors distributed over the width of the pick-up attachment, to detect the height above the ground and/or the contact pressure. However, a contact pressure control reacts so slowly that it can no longer work effectively and reactively at greater forward travel speeds. The consequence of this is poor ground adaptation of the pick-up attachment, which in turn—as explained in greater detail below—leads to harvest losses or massive fodder contamination and increased machine wear.

If the field chopper travels over a crest at a high forward advance speed, the contact pressure controller cannot lower the pick-up attachment and thereby the pick-up rotor in a timely manner, so that the attachment is guided too high for a specific time and distance, wherein the pick-up tools, in particular the raking tines, no longer reach all the way to the turf, and this leads to harvest losses, since material to be harvested is not collected. The result is therefore harvest losses that remain on the field, since it was not possible to adhere to the optimal raking height.

If the field chopper travels through a dip at an increased forward travel speed, the contact pressure control cannot raise the pick-up attachment and thereby the pick-up rotor in a timely manner, so that it is guided too low for a specific time and distance. As a result, the pick-up tools, in particular the raking tines, aggressively comb through the ground or through the turf, and this leads to massive fodder contamination and thereby a reduction in the fodder quality, damage to the turf, and increased machine wear both on the pick-up attachment and the field chopper, because a lot of dirt, in particular sand and soil, is also picked up. Also, a fracture of the pick-up tools, in particular of the raking tines, is possible.

In order for the pick-up tools, in particular the raking tines, to maintain the most optimal possible distance from the ground or for the optimal distance to come about as quickly as possible when the ground contours change, above all at higher forward travel speeds, it is known to connect the pick-up rotor to the machine frame of the pick-up attachment or to connect the pick-up attachment to the machine frame of the field chopper by way of a single-axis swing arm, so as to swing, by way of a single-axis swing arm, so as to swing. Thus, the pick-up rotor and with it the pick-up tools can adapt to different ground contours very directly and reactively, independent of a contact pressure control arranged on the field chopper, so that an optimal possible distance between the pick-up rotor and therefore the pick-up tools and the ground is maintained at all times.

A pick-up attachment in which the pick-up rotor is connected to the machine frame of the pick-up attachment by way of two swing arms or two single-axis levers, so as to swing, is known under the designation PU300 of the company CLAAS KGaA mbH. In this regard, the one swing arm or the one single-axis lever is situated on the left side, viewed in the direction of travel, and the other swing arm or the other single-axis lever is situated on the right side, viewed in the direction of travel, of the pick-up rotor, which is arranged transverse to the direction of travel. This type of connection has only one point of rotation and therefore only one rotational axis. The push point is situated on the axis of rotation of the swing arm. As a result, the pick-up rotor can better adapt to the changing ground contours.

The pick-up attachment, including the pick-up rotor, which is attached so as to swing, is driven by the harvesting machine, in particular the field chopper, in push travel. The pick-up attachment is therefore not pulled by the harvesting machine, in particular by the field chopper, but rather pushed.

The significant disadvantage of this swinging connection of the pick-up rotor to the machine frame of the pick-up attachment is the resulting thrust vector direction. Specifically, this direction points toward the ground at all times, depending on the ground contour, sometimes more and sometimes less, during push operation.

As a result, not only the weight force of the pick-up rotor but also, in addition, the push force directed toward the ground acts at the contact point, in other words where the at least one guide element connected to the pick-up rotor touches the ground. In total, a force direction vector that is directed in the direction of the ground is in effect at the contact point.

The guide elements that take on the guidance of the pick-up rotor, guide it to the ground, and have contact with the ground, can be feeler wheels, feeler skids, guide plates, or the like.

If the force direction vector—as explained above—is directed in the direction of the ground, this means that the pressure point, in other words the contact point of the guide elements with the ground, in particular the turf, and therefore the force attack point, lies below the push point, in other words below the attack point of the thrust direction vector. As a result, the pick-up rotor mounted so as to swing always has the tendency to press itself into the ground as the result of the forward movement or the push travel. In total, this therefore results in a negative force direction vector. This results in very great support forces at the guide elements of the pick-up attachment. This has the result, on wet and boggy ground, that the guide elements sink in if the ground pressure is too high, and therefore worsen the fodder quality and damage the turf as well as the pick-up tools, in particular the raking tines. Furthermore, in the case of such an embodiment, in which the thrust direction vector and the force direction vector are therefore directed toward the ground, there is a very high risk of self-locking. In this regard, the pick-up rotor with the pick-up tools would not escape upward when hitting an object, for example a contour edge or a stone, and would be damaged.

Furthermore, pick-up attachments of baling presses and loading wagons are known, in which the pick-up rotors are rigidly connected to the machine frame of the pick-up attachments, or, viewed in the forward travel direction, connected by means of a left and a right arm, so as to pivot, by way of only one point of rotation or by way of only one axis of rotation. The pick-up rotors of the pick-up attachments can therefore be lowered and raised. Furthermore, such pick-up attachments have guide wheels arranged at the side, so that the pick-up rotors can adapt to the ground contour by way of the axis of rotation and the guide wheels that are affixed on the side. However, as has already been described above, the push point lies above the contact point in the case of this pick-up attachment, as well, so that here, too, a high pressure is exerted on the guide elements. This can also lead to self-locking of the pick-up attachment in the case of push travel, so that the pick-up rotor can escape upward only with difficulty if elevated contour changes of the ground occur.

Furthermore, belt swathers from TR Engineering GmbH are known, in which a pick-up rotor, which is flexible in and of itself, is rigidly connected to a transverse conveyor belt unit and thereby rigidly connected to the machine frame of the pick-up attachment of the belt swather. In this regard, the material that is picked up is conveyed onto the belt conveyor, which moves transverse to the direction of travel. The conveyor belt then lays the material that has been picked up, i.e. the swath, down on the desired side.

Proceeding from this state of the art, the invention is based on the task of making available an improved pick-up attachment, which, in particular, overcomes the disadvantages mentioned above.

This task is accomplished, in the case of a pick-up attachment, by means of the characteristics of claim 1. Further developments and advantageous embodiments of the invention are evident from the dependent claims.

The pick-up attachment according to the invention, for a harvesting machine, preferably for a field chopper, in particular for a self-propelled field chopper, comprises a pick-up rotor having pick-up tools for picking crop up from the ground, wherein the pick-up rotor is connected to at least one guide element that rests on the ground, which element takes on the guidance of the pick-up rotor and guides it to the ground.

The pick-up rotor along with the at least one guide element is suspended on the machine frame of the pick-up attachment by way of multiple control arms, so as to swing, wherein each control arm is connected to the pick-up rotor with one end, in an articulated manner, and to the machine frame of the pick-up attachment with the other end, in an articulated manner, in such a way that during push travel of the pick-up attachment, a push point that forms the attack point of a thrust direction vector defined by the control arms is arranged below the contact point that forms between the ground and the guide element, when the pick-up rotor assumes a certain position, preferably at least when the pick-up rotor assumes a center position to a lower end position.

It is understood that depending on the context, the term pick-up rotor is understood to mean a unit that also comprises a holder or a housing for the pick-up rotor as such, for example. Accordingly, the control arms are preferably articulated onto such a holder or onto such a housing, if applicable by way of intermediate pieces. For example, the pick-up rotor can also have an intermediate frame, if this is advantageous, or can be connected with such a frame, onto which the control arms are articulated.

The position of the pick-up rotor relates to the ground contour over which the pick-up attachment is pushed. When the ground is level, the pick-up rotor is in a center position, which can also be referred to as a starting position. When the pick-up rotor swings into a dip, the pick-up rotor is in a lower position. When the pick-up rotor is at the lowest point of the dip, in other words quasi at the vertex, the pick-up rotor assumes a lower end position. When the pick-up rotor is pushed over a crest in the terrain, the pick-up rotor assumes an upper end position at the peak of the crest.

The multi-articulated, swinging suspension, according to the invention, of the pick-up rotor, by way of multiple control arms, has at least two points of rotation or at least two axes of rotation that pass through these points of rotation, and are arranged in different planes. In this sense, it is also possible to speak of a multi-axial suspension of the pick-up rotor. The kinematics of this swinging suspension of the pick-up rotor or of this system therefore comprise multiple points of rotation or axes of rotation in different planes.

According to the invention, the orientation of the control arms is such that during push travel of the pick-up attachment, the push point, which forms the attack point of a thrust direction vector defined by the control arms, lies below the contact point that forms between the ground, in particular the turf, and the guide element. The contact point is the point at which the guide element presses down onto the ground. In this regard, the contact point can also be referred to as a pressure point. The contact point or pressure point is therefore the attack point of a force vector.

The suspension of the pick-up rotor, according to the invention, describes a system having a thrust direction vector, which does not—as in the case of the state of the art—point in the direction of the ground, but rather away from the ground and therefore upward. This holds true at least when the pick-up rotor is being pushed through a dip or over a flat area. As a result, the pick-up rotor, which is suspended so as to swing, always has the tendency to lift up from the ground during push travel, i.e. due to the forward movement of the pick-up attachment. However, the weight force of the suspended pick-up rotor unit counteracts this, so that the contact between the at least one guide element and the ground or the turf remains in existence, in the desired manner.

However, the at least one guide element presses down on the ground with less force, due to the thrust direction vector that is directed upward. In other words, the contact force of the guide element on the ground and therefore the pressure on the ground is clearly reduced, according to the invention.

As a result, the pick-up rotor is guided over the ground at an optimal distance from the ground, and therefore the turf is protected because of the reduced ground pressure, in particular in the case of difficult ground conditions, for example in the case of a wet or boggy ground. Furthermore, in the case of the suspension of the pick-up rotor according to the invention, there is no risk of self-locking, since the pick-up rotor having the at least one guide element already has a tendency—as has already been explained—to escape upward if it strikes an obstacle or in the case of elevated contour changes. In this way, optimal and secure guidance of the pick-up rotor over the ground and thereby great raking precision as well as quiet running of the pick-up attachment are guaranteed.

In summary, therefore, the following advantages occur—also in combination with one or more than one characteristic of the advantageous embodiments and further developments that will be named below. The pick-up rotor of the pick-up attachment has better ground adaptation, above all in the case of greater working widths and higher forward travel speeds. The quiet operation of the pick-up rotor is greater, so that the pick-up rotor, which is suspended so as to swing, neither locks up nor jumps. The ground pressure on the guide elements is less, and thereby the turf is protected and the raking height, above all in wet and boggy regions, is adhered to. The fodder quality is increased, since less dirt is introduced into the fodder. The wear of the entire pick-up attachment and thereby of the harvesting machine is reduced. As a result, the risk of tine breaks is also reduced. Because of the better raking quality, the harvesting losses when picking the crop up from the ground are reduced.

The machine frame can also have an intermediate frame or be connected with such a frame, on which the control arms are suspended, if this is practical.

It can be advantageous if the control arms are arranged in such a manner that the push point when pushing the pick-up attachment through a dip is arranged farther below the contact point than when pushing the pick-up attachment over even ground.

It can be advantageous if, during push travel of the pick-up attachment, the push point is arranged above the contact point when the pick-up rotor is pushed over a crest, in particular if the pick-up rotor is approaching its upper end position.

It can be advantageous if the multiple control arms comprise at least one upper control arm and at least one lower control arm, which are arranged relative to one another in such a manner that they have an intersection point, in the case of an imaginary or projected extension of their control arm direction, counter to the push direction of the pick-up attachment, which point forms the push point. The push point forms an instantaneous center.

For some purposes of use, it can be advantageous if the control arms are uniformly distributed over the width of the pick-up rotor or of the machine frame. For other purposes of use, it can be advantageous if the control arms are non-uniformly distributed over the width of the pick-up rotor or of the machine frame, in other words transverse to the direction of travel.

It can be advantageous if more lower control arms are provided than upper control arms.

In the case of a pick-up rotor having a width of three meters, for example, it can be practical to provide two lower control arms and one upper control arm.

It can be advantageous if a weight force acts on the pick-up rotor that is suspended to as to swing, which force is selected in such a manner that the contact between the ground and the guide element is guaranteed during push travel and changing ground contours.

It can be advantageous if the length of at least one control arm, in particular of the upper and/or lower control arm, can be changed or adjusted.

As a result, depending on the purpose of use of the pick-up attachment, the location of the push point or of the instantaneous center can be changed and adjusted in a desired, advantageous manner. In other words, in this way the kinematics of the swinging system can be influenced in a desired manner.

It can be advantageous if the machine frame of the pick-up attachment has at least one guide roller at the end that faces the harvesting machine, wherein the guide roller has ground contact in a starting position, in which the pick-up rotor is in a center position, and therefore the pick-up attachment quasi stands on the same plane with the at least one guide element, wherein the pick-up attachment is brought back into the starting position, in each instance, by way of a contact pressure controller provided on the harvesting machine, if the pick-up attachment is being pushed through a dip or over a crest during push travel.

This height guidance of the pick-up attachment, by way of the contact pressure controller provided on the harvesting machine, which guidance is known as such, in combination with the up and down swing of the pick-up rotor relative to the machine frame of the pick-up attachment, according to the invention, are advantageously superimposed on one another as follows. The pick-up rotor that swings, according to the invention, adapts directly and reactively to the ground contours, and thereby keeps the raking height constant, even at higher forward speeds. The harvesting machine, for example the field chopper, makes the pick-up attachment track more slowly on the at least one guide roller, by way of the contact pressure controller, since the contact pressure controller reacts more slowly. In this way, the result is achieved that the contact pressure controller regulates the height of the pick-up attachment in such a manner that the swinging pick-up rotor always returns to its center position, in other words to the aforementioned starting position.

It can be advantageous if the at least one guide roller is arranged within the working width of the pick-up attachment.

It can be advantageous if at least one sensor, preferably an angle sensor, is provided, which detects the relative movement between the pick-up rotor and the machine frame of the pick-up attachment and transforms it into an electrical signal, which can be used for controlling a pre-compression housing that is arranged on the pick-up attachment, which housing can be controlled in such a manner that the swinging pick-up rotor finds its way back into a starting position, in which the pick-up rotor is situated in a center position, and the pick-up attachment quasi stands on the same plane with the at least one guide element.

The relative movement is therefore advantageously utilized to implement an electronic height guide. The relative movement between the pick-up rotor and the machine frame, detected by way of one or more than one sensor, for example an angle sensor, is transformed into one or more than one electrical signal. This signal is then utilized to detect the position of the pick-up rotor relative to the machine frame, and can be passed on to the harvesting machine, for example a corn chopper. While the pick-up rotor, which swings according to the invention, adapts itself directly and reactively to the ground contours, and thereby keeps the raking height constant even at higher advancing speeds, the harvesting machine tracks the pre-compression housing, using the position signal, in such a manner that the swinging pick-up rotor always finds its way back to its center position, in other words to the aforementioned starting position. The guide rollers mentioned above are not compulsory in the case of the present electronic height guidance, but can support the ground guidance under difficult ground conditions.

It can be advantageous if the pick-up attachment connected to the harvesting machine is manually adjustable on the harvesting machine, to a constant, predetermined height above the ground.

The pick-up rotor, which is suspended so as to swing, according to the invention, therefore adapts itself to the ground contours without the aforementioned additional contact-pressure-controlled or electronically controlled height guidance of the pick-up attachment. Specifically in the case of older harvesting machines, the height of the pick-up attachment can only be set manually to a constant height. The pick-up rotor that is suspended so as to swing, according to the invention, then only adapts to the ground contours within its swing path. In the case of more extreme unevenness of the ground, the height of the pick-up attachment should be adjusted manually, especially proceeding from the harvesting machine, for example proceeding from the cabin of a field chopper.

Such a harvesting machine, with manual adjustment of the height guidance of the pick-up attachment according to the invention, should therefore be used predominantly on level terrains. In hilly and/or alpine regions, the pick-up rotor that is suspended to swing, according to the invention, should be used only in combination with a corresponding contact-pressure controlled or electronically controlled height guidance of the pick-up attachment.

It can be advantageous if at least one control arm are additionally connected, by way of at least one stress-relief element, for example by way of a pressure spring or tension spring, preferably by way of at least one tension spring, with the machine frame of the pick-up attachment, in such a manner that the pick-up rotor is supportively pulled upward at least when traveling through a dip or when traveling over a plane.

As a result, the swinging system, which has multiple control arms, is additionally relieved of stress. The pressure of the at least one guide element, for example a slide plate or a guide skid, on the ground is further reduced, and thereby the pick-up attachment runs more quietly and the ground is protected.

It can be advantageous if the pick-up rotor is composed of multiple segments that are connected to one another in an articulated manner, at least in part, for adaptation to the contours of the ground. Because of the fact that the pick-up rotor of the pick-up attachment is composed of multiple segments that are connected to one another in an articulated manner, at least in part, the result is achieved that the pick-up rotor is flexible also crosswise to the direction of travel, and thereby it can better adapt to the ground contour. Thus, it is possible that the pick-up rotor adapts itself to the contour of a dip when traveling over a dip or, vice versa, to the contour of an elevation when traveling over an elevation, at least in part.

In this regard, the pick-up rotor quasi hangs through downward at the location in question or, vice versa, arches upward at the location in question. Because of the fact that the pick-up rotor adapts itself to the contour of the field surface, the pick-up rotor and thereby the pick-up tools, in particular raking tines, can be guided at an optimal distance from the turf, so as to pick up the crop. Therefore no harvest losses occur, since the harvested material is reliably gathered together even in dips. Furthermore, the pick-up tools, in particular raking tines, are prevented from combing through the turf aggressively. Since the turf is thereby protected and no dirt, such as sand or soil, is picked up, fodder contamination is prevented and the fodder quality is increased. The flexibility of the pick-up rotor therefore guarantees high fodder quality with low harvest losses. Furthermore, increased machine wear is prevented both on the pick-up attachment and on the harvesting machine.

By means of the combination of the swinging suspension of the pick-up rotor, according to the invention, with the flexibility of the pick-up rotor, wherein preferably multiple guide elements distributed over the working width are provided, the result is achieved, for one thing, that the ground pressure is divided up onto multiple guide elements, for example slide plates or slide skids, and for another thing, that the flexible pick-up rotor can adapt itself to the ground contours, in addition to the swinging suspension, also transverse to the direction of travel. As a result, an optimal raking accuracy is achieved, and thereby, once again, the ground is protected.

It can be advantageous if, aside from the field chopper that has already been mentioned, the harvesting machine is a baling press, a loading wagon, a belt swather, or the like. Possible machines are, fundamentally, all agricultural machines that can usually be equipped with a pick-up attachment as a harvesting attachment.

As has already been explained, it can be advantageous if multiple guide elements are provided, distributed over the working width of the pick-up attachment, which elements take on the guidance of the pick-up rotor and/or guide it to the ground. Preferably, no guide elements are provided that are arranged laterally next to the pick-up rotor.

It can be advantageous if the guide elements are arranged below and/or directly behind the pick-up rotor and/or within its effective working width. As a result, the pick-up rotor can adapt itself to the ground contours of the terrain over its entire working width.

It can be advantageous if the guide elements are configured, at least in part, as slide plates.

It can be advantageous if the pick-up rotor is structured as an uncontrolled pick-up rotor having pick-up tools that are preferably arranged degressively, preferably tines that are arranged degressively. In the uncontrolled version, the tines extend along a circular path and can rotate about a fixed axis of rotation. In the controlled version, in contrast, the tines would be able to tilt in addition to the rotational movement and/or to move in and out, wherein the aforementioned rotational movement oven deviates from a circular shape. The tines are spring tines that have the form of a torsion spring having long shanks as a recognition characteristic. The spring tines can be configured as double torsion springs. Degressively means that the shanks of the tines or spring tines are angled away or bent opposite to the direction of rotation.

Further characteristics of the invention are evident from the claims, the figures, and the figure description. All of the characteristics and combinations of characteristics mentioned above in the specification, as well as the characteristics and combinations of characteristics below, in the figure description, or only shown in the figures, can be used not only in the combination indicated, in each instance, but also in other combinations or by themselves.

The invention will now be explained in greater detail using preferred exemplary embodiments and making reference to the attached drawings. These show:

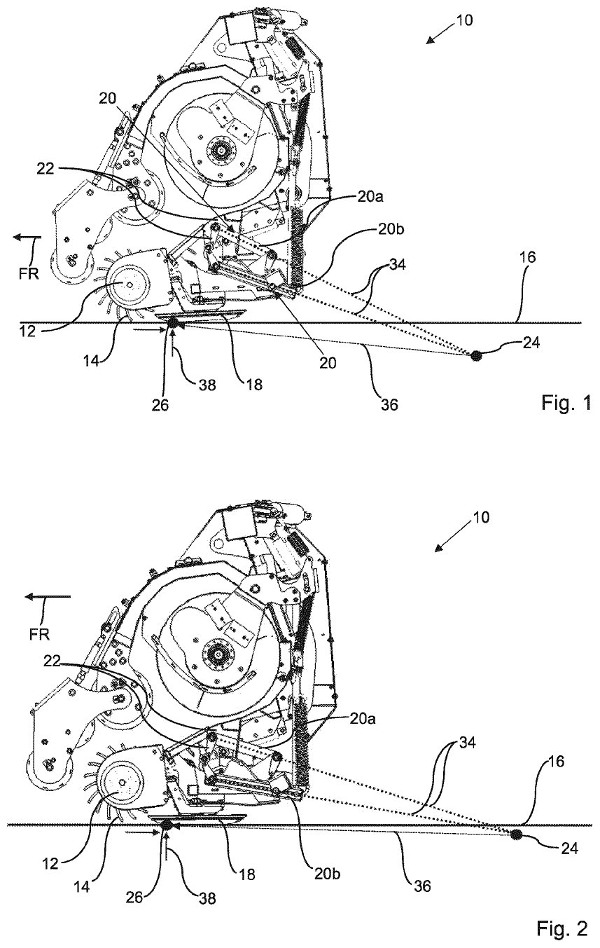

FIG. 1 a schematic side view of a pick-up attachment according to the invention, having a pick-up rotor, in a lower end position,

FIG. 2 a schematic side view of the pick-up attachment according to the invention, according to FIG. 1, with the pick-up rotor in a center position,

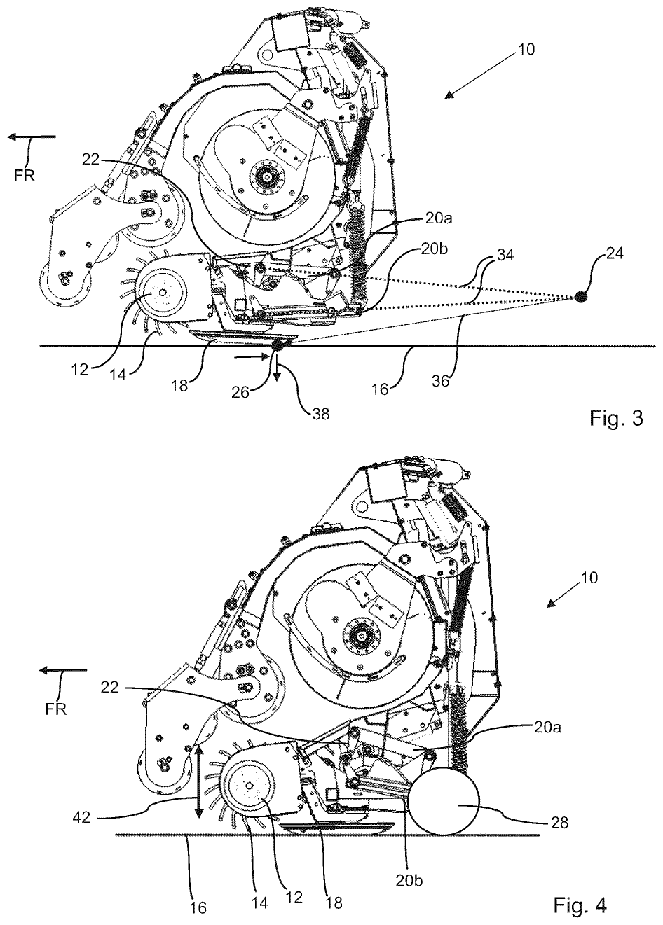

FIG. 3 a schematic side view of the pick-up attachment according to the invention, according to FIG. 1, with the pick-up rotor in an upper end position,

FIG. 4 a schematic side view of the pick-up attachment according to the invention, according to FIG. 2, in addition with at least one guide roller, and

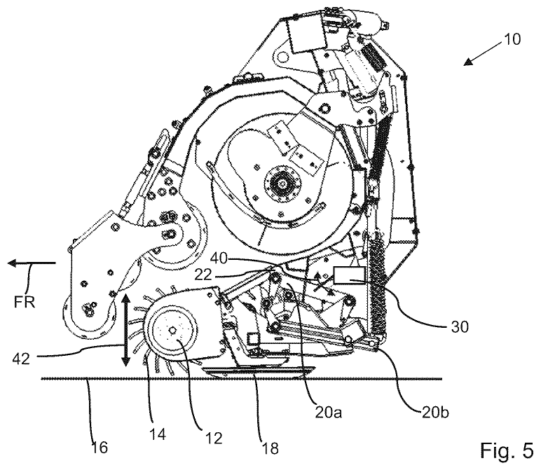

FIG. 5 a schematic side view of the pick-up attachment according to the invention, according to FIG. 2, in addition with an angle sensor.

If the same reference numbers are used in FIG. 1 ∘5, they also refer to the same parts or regions.

FIG. 1 shows a schematic side view of a pick-up attachment 10 according to the invention, for a harvesting machine that is not shown here, in particular for a self-propelled field chopper. The pick-up attachment 10 comprises a pick-up rotor 12 having pick-up tools 14 for picking crop up from the ground 16, wherein the pick-up rotor 12 is connected to at least one guide element 18 that lies on the ground 16, which element is configured, in the present case, as a slide plate. The guide element 18 takes on the guidance of the pick-up rotor 12 and guides it to the ground 16. The ground 16 usually forms the turf. According to the invention, it is provided that the pick-up rotor 12, together with the at least one guide element 18, is suspended on the machine frame 22 of the pick-up attachment 10 by way of multiple control arms 20, so as to swing, wherein each control arm 20 is connected to the pick-up rotor 12 with one end, in an articulated manner, and to the machine frame 22 of the pick-up attachment 10 with the other end, in an articulated manner. In the present case, a pair of control arms composed of an upper control arm 20a and a lower control arm 20b is shown, which are arranged relative to one another in such a manner that they have an intersection point, in the case of an imaginary extension 34 of their control arm direction, counter to the push direction of the pick-up attachment 10, which point forms the push point 24, which is an instantaneous center.

The control arms 20 are positioned relative to one another in such a manner that during push travel, in other words forward travel of the pick-up attachment 10, the push point 24, which forms the attack point of a thrust direction vector 36 defined by the control arms 20, is arranged below the contact point 26 that forms between the ground 16 and the guide element 18 when the pick-up rotor 12 assumes a certain position, for example when the pick-up rotor 12 assumes a lower end position, as shown in FIG. 1, or when the pick-up rotor 12 assumes a center position, as shown in FIG. 2.

The position of the pick-up rotor 12 on the pick-up attachment 10 depends on the ground contour over which the pick-up attachment 10 is being pushed. If the ground 12 is level, the pick-up rotor 12 is situated in a center position. The guide element 18, in the form of a slide plate, is set down on the ground 16 quasi with its full area, as shown in FIG. 2. If the pick-up rotor 12 swings into a dip, the pick-up rotor 12 is situated in a lower position. If the pick-up rotor 12 is at the lowest point of the dip, in other words quasi at the vertex, the pick-up rotor 12 assumes a lower end position, as shown in FIG. 1. It is good to recognize that the rear region of the guide element 18 rises up slightly. The contact point 26 lies at the front. If the pick-up rotor 12 is pushed over a crest, the pick-up rotor 12 assumes an upper end position at the highest point of the crest, as shown in FIG. 3. There, it is easy to see that the front region of the guide element 18 rises up slightly. The contact point 26 lies at the back.

The direction of travel FR, i.e. the forward travel direction of the pick-up attachment 10, is indicated with an arrow in the figures.

The suspension of the pick-up rotor 12 by way of the upper control arm 20a and the lower control arm 20b is a four-joint suspension, in which the pick-up rotor 12 swings quasi vertically. Because of the four-joint suspension, there are therefore two axes of rotation, which are arranged in different planes.

The contact point 26 is the point at which the guide element 18 presses down onto the ground 16. In this regard, the contact point 26 can also be referred to as a pressure point. The contact point 26 or pressure point is therefore the attack point of a force vector 38.

The suspension of the pick-up rotor 12, according to the invention, has a thrust direction vector 36, as shown in FIGS. 1 and 2, that does not point—as in the state of the art—in the direction of the ground 16, but rather away from the ground 16 and therefore upward, when the pick-up rotor 12 is pushed through a dip or over a plane. As a result, the pick-up rotor 12, which is suspended so as to swing, always has the tendency to lift up off the ground 16 during push travel in the direction of travel FR or on the basis of the forward movement of the pick-up attachment 10. This lifting is counteracted by the weight force, not shown here, of the suspended pick-up rotor unit, so that the contact between the at least one guide element 18 and the ground 16 or the turf remains in existence in the desired manner at all times.

However, the at least one guide element 18 presses down on the ground 16 with less force because of the thrust direction vector 36, which is directed upward. In other words, the contact force of the guide element 18 onto the ground 16 and thereby the pressure on the ground 16 is clearly reduced according to the invention. The advantages achieved as a result have already been described extensively.

As can be seen well in a comparison of FIGS. 1 and 2, it is advantageous if the control arms are arranged in such a manner that the push point 24 when pushing the pick-up rotor 12 through a dip is arranged lower underneath the contact point 26 than when pushing the pick-up roller 12 over a level ground 16.

FIG. 3 shows a schematic side view of the pick-up apparatus 10 according to the invention, according to FIG. 1, with the pick-up rotor 10 in the upper end position. Here it is advantageous that during push travel of the pick-up attachment 10, the push point 24 lies above the contact point 26.

FIG. 4 shows a schematic side view of the pick-up apparatus 10 according to the invention, according to FIG. 2, in addition with at least one guide roller 28, which is arranged at the end of the machine frame 22 of the pick-up attachment 10 that faces the harvesting machine, wherein the guide roller 28 has ground contact in a starting position in which the pick-up rotor 12 is in a center position, as shown in FIG. 2, in other words the pick-up rotor 12 is quasi guided over a plane with the at least one guide element 18, wherein the pick-up attachment 10 is brought back into the starting position by way of a contact pressure controller provided on the harvesting machine when the pick-up attachment 10 is pushed through a dip or over a crest during push travel.

FIG. 5 shows a schematic side view of the pick-up attachment 10 according to the invention, according to FIG. 2, in addition with an angle sensor 30. The schematically shown angle sensor 30 detects the relative movement 40 between the pick-up rotor 12 and the machine frame 22 of the pick-up attachment 10, and transforms the detected value into an electrical signal that can be used to control a pre-compression housing 32 arranged on the pick-up attachment 10, which housing is controlled in such a manner that the swinging pick-up rotor 12 finds its way back into a starting position, in which the pick-up rotor 12 is situated in a center position, as shown in FIG. 2.

The one or more than one guide element 18 is arranged directly under or behind the pick-up rotor 12 and within the effective working width of the pick-up rotor 12.

To further improve the kinematics and to reduce the ground pressure, the pick-up rotor 12 can be relieved of stress by means of stress-relief elements such as tension springs or pressure springs, for example, not shown here. When the pick-up rotor 12 with the control arms 20 is in the lower end position, as shown in FIG. 1, in other words it is passing through a dip, the spring is completely tensed and the pick-up rotor 12 is thereby maximally relieved of stress. When the pick-up rotor 12 is in the upper end position, as shown in FIG. 3, in other words it 12 travels over a crest, the spring is relaxed or less tensed, so that the pick-up rotor 12 presses down onto the ground 16 with a weight approaching its inherent weight.

### REFERENCE SYMBOL LIST

10 pick-up attachment
12 pick-up rotor
14 pick-up tool
16 ground
18 guide element
20 control arm
20a upper control arm
20b lower control arm
22 machine frame
24 push point
26 contact point
28 guide roller
30 angle sensor
32 pre-compression housing
34 extension
36 thrust vector direction
38 force vector
40 relative movement
42 oscillating movement
FR direction of travel

1. A pick-up attachment (10) for a harvesting machine, preferably for a field chopper, comprising a pick-up rotor (12) having pick-up tools (14) for picking crop up from the ground (16), wherein the pick-up rotor (12) is connected to at least one guide element (18) that rests on the ground (16), which element takes on the guidance of the pick-up rotor (12) and guides it to the ground (16), wherein the pick-up rotor (12) along with the at least one guide element (18) is suspended on the machine frame (22) of the pick-up attachment (10) by way of multiple control arms (20), so as to swing, wherein each control arm (20) is connected to the pick-up rotor ((12) with one end, in an articulated manner, and to the machine frame (22) of the pick-up attachment (10) with the other end, in an articulated manner, in such a way that during push travel of the pick-up attachment (10), a push point (24) that forms the attack point of a thrust direction vector defined by the control arms (20) is arranged below the contact point (26) that forms between the ground (16) and the guide element (18), when the pick-up rotor (12) assumes a certain position, preferably at least when the pick-up rotor (12) assumes a center position to a lower end position.

2. The pick-up attachment (10) according to claim 1, wherein the control arms (20) are arranged in such a manner that the push point (24), when pushing the pick-up attachment (10) through a dip, is arranged lower below the contact point (26) than when pushing the pick-up attachment (10) over a plane.

3. The pick-up attachment (10) according to claim 1, wherein during push travel of the pick-up attachment (10), the push point (26) is arranged above the contact point (24) when the pick-up rotor approaches its upper end position.

4. The pick-up attachment (10) according to claim 1, wherein the multiple control arms (20) comprise at least one upper control arm (20a) and at least one lower control arm (20b), which are arranged relative to one another in such a manner that they have an intersection point, in the case of an imaginary extension (34) of their control arm direction, counter to the push direction of the pick-up attachment (10), which point forms the push point (24).

5. The pick-up attachment (10) according to claim 1, wherein the control arms (20) are uniformly or non-uniformly distributed over the width of the pick-up rotor (12) or of the machine frame (22).

6. The pick-up attachment (10) according to claim 1, wherein more lower control arms are provided than upper control arms.

7. The pick-up attachment (10) according to at least one of the preceding claims, characterized in that claim 1, wherein a weight force acts on the pick-up rotor (12) that is suspended to as to swing, which force is selected in such a manner that the contact between the ground (16) and the guide element (18) is guaranteed during push travel and changing ground contours.

8. The pick-up attachment (10) according to claim 1, wherein the length of the control arms (20), in particular of the upper (20a) and/or lower control arm (20b), can be changed and adjusted.

9. The pick-up attachment (10) according to claim 1, wherein the machine frame (22) of the pick-up attachment (10) has at least one guide roller (28) at the end that faces the harvesting machine, wherein the guide roller (28) has ground contact in a starting position, in which the pick-up rotor (12) is in a center position, and therefore the pick-up attachment (10) quasi stands on the same plane with the at least one guide element (18), wherein the pick-up attachment (10) is brought back into the starting position, in each instance, by way of a contact pressure controller provided on the harvesting machine, if the pick-up attachment (10) is being pushed through a dip or over a crest during push travel.

10. The pick-up attachment (10) according to claim 1, wherein the at least one guide roller (28) is arranged within the working width of the pick-up attachment (10).

11. The pick-up attachment (10) according to claim 1, wherein at least one sensor, preferably an angle sensor (30), is provided, which detects the relative movement between the pick-up rotor (12) and the machine frame (22) of the pick-up attachment (10) and transforms it into an electrical signal, which can be used for controlling a pre-compression housing (32) that is arranged on the pick-up attachment (10), which housing can be controlled in such a manner that the swinging pick-up rotor (12) finds its way back into a starting position, in which the pick-up rotor (12) is situated in a center position, and the pick-up attachment (10) quasi stands on the same plane with the at least one guide element (18).

12. The pick-up attachment (10) according to claim 1, wherein the pick-up attachment (10) connected to the harvesting machine is manually adjustable on the harvesting machine, to a constant, predetermined height above the ground.

13. The pick-up attachment (10) according to claim 1, wherein at least one control arm (20) is additionally connected, by way of at least one stress-relief element, preferably a pressure spring or very particularly preferably a tension spring, with the machine frame (22) of the pick-up attachment (10), in such a manner that the pick-up rotor (12) is supportively pulled upward at least when traveling through a dip or when traveling over a plane.

14. The pick-up attachment (10) according to claim 1, wherein the pick-up rotor (12) is composed of multiple segments that are connected to one another in an articulated manner, at least in part, for adaptation to the contours of the ground (16).

15. The pick-up attachment (10) according to claim 1, wherein the harvesting machine is a baling press, a loading wagon, a belt swather, or the like.
